(19) United States
(12) Patent Application Publication
(10) Pub. No.: US 2022/0089467 A1
(43) Pub. Date: Mar. 24, 2022

(54) Biogas production with select macro algae and nanoparticles added to anaerobic digester feedstock

(71) Applicant: Roger Peters Garth Bason, Red Hook, NY (US)

(72) Inventor: Roger Peters Garth Bason, Red Hook, NY (US)

(21) Appl. No.: 17/027,997

(22) Filed: Sep. 22, 2020

(51) Int. Cl. C02F 3/28; C02F 11/04; C02F 3/32; C05F 3/06

(52) U.S. Cl. CPC C02F 3/286; C02F 11/04; B82Y 30/00; C05F 3/06; C02F 3/322

(57) ABSTRACT

For qualitative and quantitative production of biogas, nanoparticles and use of macroalgae when added to AD feedstock at proper concentration, temperature and time of digestion can bring a revolution to meet the future needs of energy. The process of biofuel production can be altered by using various nanomaterials in various ways, such as by improving the stability of cellulose enzymes, enhancing the catalytic production of biohydrogen, and improving biological and chemical digestion. This influence of nanoparticles on the process is determined by their distinct catalytic activity based on structure, shape and size which is complementary to the relevant process. The addition of seaweed in the AD feedstock improves biogas output and digestate quality thus enhancing the economic viability with the simultaneous positive impact of reducing global warming.

### REFERENCE

Faisal, Shah et al. “A Review of Nanoparticles as Boon for Biogas Producers—Nano Fuels and Biosensing Monitoring”. Applied Sciences, Dec. 25, 2018.

### FIELD OF INVENTION

The invention presents a method for increasing biogas production and improving the quality of the resultant digestate for agricultural use as a soil conditioner and fertilizer by adding specific species of seaweeds (macroalgae) in dry or wet states and nanoparticles (NP) of specified chemical composition, size and concentration to anaerobic digester (AD) feedstock at a given temperature for a specific period of time.

The seaweed will augment the quantity and quality of biogas production as well as the potential generation of electricity and heat from anaerobic digestion energy systems that utilize commonly available organic wastes such as animal manures, wastewater, or organic foods wastes as feedstock. The addition of nanoparticles improves the reactivity and conversion of AD constituents and results in higher concentrations of methane, hydrogen and biogas production. The addition of macroalgae and NP to the feedstock enables an optimization of the AD process. Whereas conventional biogas production can convert only 30% to 40% of the feedstock organic matter, this invention enables optimal conversion of feedstock that improves overall biogas production by 40% to 200%.

Efforts are being made globally to cut down the use of fossil fuels and the emission of Carbon in order to reduce the impacts of global warming. There is a growing awareness and emphasis on the carbon-neutral operation of biofuels. Production of methane is obtained by converting organic matter contained in sludge through the anaerobic process of wastewater treatment and other organic agricultural livestock or food wastes. However, the wide application of AD has always been limited due to the low energy conversion efficiency of the sludge or organic feedstocks. To overcome this issue and enhance methane production, nanomaterials and marine algae have been recommended as additives to the feedstock after effective trials (Faisal, 2018 and Atlantic Ocean Aquaculture, 2020). Biomass, such as municipal and agricultural waste, still possesses a huge potential to improve industrial AD through the use of nanomaterials, particularly with the use of NP along with seaweeds, as such macroalgae also capture Carbon and reduce Ocean Acidification while they grow in the marine environment prior to harvest.

This invention proposes a method to increase biogas production in AD systems by adding Fe₃O₄ nanoparticles of critical size (5 nm to 1000 nm) that combined with wet or dry seaweeds (Specific Phylum Phaeophyta Seaweed species include: Ascophyllum nodosum, Saccharina Latissima, and Laminarian digitata) and will augment and improve the quality and quantity of biogas production with notably more Hydrogen gas and higher heat value when compared with conventional biogas methane production and a greater quantity of gas due to the addition of the chemical nutrients in the seaweed and the mechanical breakdown and improved reactivity of the organic wastes in the feedstock due to the physical structure, size and action of the NP.

Nanotechnology has been determined to have a positive impact when applied to biotechnological applications in the form of nanoparticles particularly with respect to improving biogas production in AD systems. The current use of NP in bioenergy production from biomass is very restricted. It is noteworthy however that recent findings, clearly identify significant advantages in the utilization of NP as an additive in the AD processes. These AD processes utilize bacteria to break down natural substances particularly waste products such as manure, wastewater treatment plant outfalls, food wastes and other organic process waste materials that are commonly used in AD processes worldwide. While minute NP are unstable, they can be designed to provide ions in a controlled approach to enable the maximum enhancement of biogas and associated electricity and heat.

### BACKGROUND

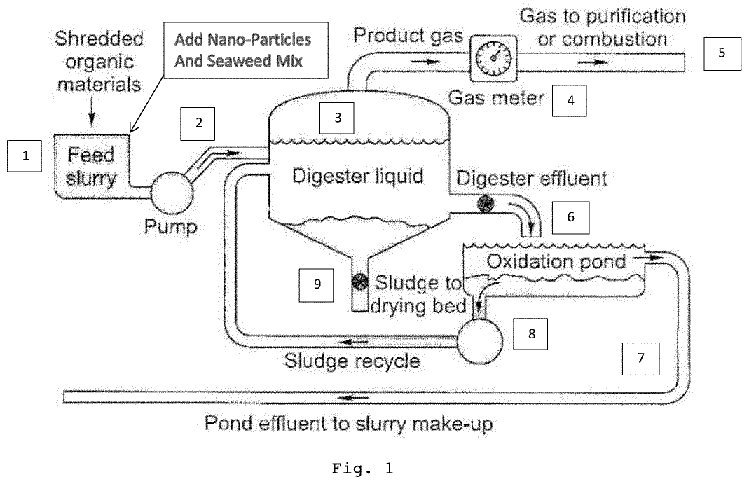

A conventional anaerobic digester system generally includes the following components (see DRAWING FIG. 1): (1) manure transfer and mixing pit by which to add shredded organic materials to a feed slurry, (2) pump and piping to deliver the feedstock mix into (3) a digester made of steel, fiberglass, concrete, geotextile, plastic, earth or other suitable material (including heating and mixing equipment if needed), (4) piping to direct product gas to (5) a gas purifier and/or combustion for electricity generation or heat, (6) piping and pumps to transfer liquid effluent to an oxidation pond to deliver and add this liquid to (7) slurry make up or (8) for recycling back to the digester and (9) piping/pumps to remove solid wastes from digester to a drying bed for use of solid wastes as fertilizer. Conventional anaerobic digester systems require proper design and sizing to maintain critical bacterial populations responsible for waste treatment and stabilization for sustained long-term predictable performance.

Sizing requirements are based on hydraulic retention time (HRT) and loading rate where the operating temperature can affect overall size and gas output parameters. These factors (size, materials, mixing methods, and other operational requirements) affect digester costs and operational needs.

Process stages. The stages of anaerobic digestion include hydrolysis, acidogenesis, acetogenesis and methanogen esis. The overall process can be described by the chemical reaction, where organic material such as glucose is biochemically digested into carbon dioxide (CO₂) and methane (CH₄) by the anaerobic microorganisms.

C₆H₁₂O₆→3CO₂+3CH₄

Hydrolysis. In most cases, biomass is made up of large organic polymers. For bacteria in anaerobic digesters to access the energy potential of the material, these chains must first be broken down into their smaller constituent parts. These constituent parts, or monomers, such as sugars, are readily available to other bacteria. The process of breaking these chains and dissolving the smaller molecules into solution is called hydrolysis. Therefore, hydrolysis of these high-molecular-weight polymeric components is the necessary first step in anaerobic digestion. Through hydrolysis the complex organic molecules are broken down into simple sugars, amino acids, and fatty acids. Acetate and hydrogen produced in the first stages can be used directly by methanogens. Other molecules, such as volatile fatty acids (VFAs) with a chain length greater than that of acetate must first be catabolized into compounds that can be directly used by methanogens.

Acidogenesis. The biological process of acidogenesis results in further breakdown of the remaining components by acidogenic (fermentative) bacteria. Here, VFAs are created, along with ammonia, carbon dioxide, and hydrogen sulfide, as well as other byproducts. The process of acidogenesis is similar to the way milk sours.

Aceto-genesis. The third stage of anaerobic digestion is aceto-genesis. Here, simple molecules created through the acidogenesis phase are further digested by acetogens to produce largely acetic acid, as well as carbon dioxide and hydrogen.

Methanogenesis. The terminal stage of anaerobic digestion is the biological process of methanogenesis. Here, methanogens use the intermediate products of the preceding stages and convert them into methane, carbon dioxide, and water. These components make up the majority of the biogas emitted from the system. Methanogenesis is sensitive to both high and low pH and occurs between pH 6.5 and pH 8. The remaining, indigestible material the microbes cannot use and any dead bacterial remains constitute the digestate.

### Existing Approaches to Improve Biogas Efficiency

While biogas production by AD holds great promise for greater global acceptance, the process has a relative low level of energy conversion as the feedstock digestion efficiency generally ranges from 30% to 40% thus limiting the overall quantity and quality of Methane (CH₄), Hydrogen (H₂), and biogas produced that can include Carbon Dioxide (CO₂) Hydrogen Sulfide (H₂S) and other non-volatile gases. This low level of potential energy output combined with the relatively high cost of capital construction for industrial scale biogas plants has limited the overall potential for greater success and distribution of this technology at industrial scale worldwide.

### SUMMARY OF THE PRESENT INVENTION

Accordingly, there has been a need for a novel improved anaerobic digester system and method for treating animal waste, manures, municipal wastewater or food wastes that may comprise the biogas system feedstock. As AD is essentially a mature industry and operation, production methods and system design are generally predictable, effective, durable, affordable for small scale systems, simple to operate, portable, and environmentally friendly. There is a further need for a novel improved anaerobic digester and method for primary waste treatment and biogas production for the small, medium, and large-scale farms to improve overall output and efficiency. The present invention fulfills these needs and provides other related advantages particularly high value fertilizer.

The specific shortcomings then where improvements are directed include incomplete digestion of the feedstock, resulting in poor biogas production, that limits the power production via electrical conversion, and providing less gas available for the production of heat. These shortcomings reduce the economic return from biogas plant operations and limit the sale of product outputs and subsequent revenue.

Other limitations that reduce operational efficiency of industrial scale plants include poor biodigestibility, unstable fermentation and low methane production. Attempts to resolve these essential problems with industrial scale biogas units generally fall into three basic approaches that include;
1. Pre-treatment of the input sludge including pre-heating,
2. Changes or adjustments in the feedstock mix that includes varying the proportions of manure, wastewater and other organic food wastes,
3. Changes in the digestive system including adjustments in the mix of temperature, AD time, and addition of supplements to feedstock.

This invention relates to this third option (3) of providing an optimized micro-environment that is produced by the addition of macroalgae and nano-particles to enable a more complete digestion of the feedstock organics based on improved physical, biological and chemical conditions that support and promote bacterial action. These optimal conditions are supplied by the invention mix of temperature, time of digestion, size of Fe₃O₄ particles (5 nm to 1,000 nm), of variable concentration and seaweed (macroalgae species) slurry or colloidal mix that consists of approximately between 2% and 20% of the total biogas feedstock by weight. Therefore:

In relation to microorganisms, there are two aspects to the impact of iron (Fe₃O₄ particles): (1) it serves as an essential trace element for anaerobe microbes and improves competition with sulphate reducing bacteria (SRB) leading to the growth and reproduction of methane producing microbes; (2) activities of the enzymes involved in methanogenesis and acidogenesis can be stimulated by iron due to its ability to improve basic elements in metallic-enzymes. The referenced analysis strongly suggests that both metabolically and technically, enhancement of AD by nano-ions is feasible and effective. Energy recovery through iron-based anaerobic digestion is a sustainable and promising strategy that covers many cross disciplinary fields. This technique can result in a novel industrial chain because it can interlink wastewater treatment, the steel industry, dairy and livestock agriculture and renewable energy generation.

Due to the presence of Fe₃C and non-toxic Fe₃C ions, methane production can be enhanced by a nano iron oxide (Fe₃O₄ NPs) and particularly nanoparticles of Fe₃O₄ from 5 nm to 1000 nm in size. When these materials were added to an anaerobic waste digester with variable concentrations at 37° C. for 20 to 60 days, there was an increase of 234% in methane production and 180% in biogas production, which could be considered the highest and most remarkable increase in biogas production using nanoparticles (Faisal, 2018).

By stimulating the bacterial growth, magnetite NPs (Fe₃O₄ NPs) can enhance methane production. The particle size, time and concentration determine whether there is enhancement, inhibition or adverse effects of energy conversion.

What is claimed is:

1. A process for the production of biogas from biodegradable material which comprises the steps of:
(a) adding the biodegradable material to the reactor;
(b) adding manure to the feedstock;
(c) adding a colloidal solution of surface-modified iron oxide nanoparticles and seaweed to the reactor;
(d) providing anaerobic conditions;
(e) carrying out the anaerobic digestion and collecting the biogas, liquid and solid wastes.

2. The process of claim 1 wherein the addition of NP results in greater optimization of the AD process and when combined with organic wastes in the AD feedstock will result in higher output of methane (CH₄), Hydrogen (H₂) and biogas.

3. The process of claim 1 wherein macroalgae in the form of specific seaweed species are added to the reactor to improve the nutrient content, biogas output and value of resultant digestate as a soil conditioner and fertilizer.

4. The process of claim 1 wherein the NP size (5 nm to 1,000 nm), composition (Fe₃O₄), at variable concentrations and AD process temperature (37° C.) and time (20 to 60 days) results in highly efficient biogas production.

5. The process of claim 1 wherein the mixture of seaweed species (Ascophyllum nodosum, Saccharina latissimi, Laminaria digitata, and Sargassum spp.) in wet or dry forms improves AD feedstock digestion, overall output of both the quantity and quality of biogas production and nutrient value of the resultant digestate for use as fertilizer.

6. The process of claim 1 wherein the addition of Ascophyllum nodosum in dry, powdered, wet or colloidal suspension to Nanoparticles of Fe₃O₄ from 5 nm to 1,000 nm in size will result in improved biogas production.
